(19) United States
(12) Patent Application Publication
(10) Pub. No.: US 2021/0201363 A1
(43) Pub. Date: Jul. 1, 2021

(54) MARKETING PLATFORM

(71) Applicant: Capital One Services, LLC, McLean, VA (US)

(72) Inventors: Parvesh KUMAR, Plano, TX (US); Terry NI, McKinney, TX (US); Raman BAJAJ, Frisco, TX (US); Praveen TANDRA, Allen, TX (US); Janardhan PRABHAKARA, Allen, TX (US); Sanjiv YAJNIK, Dallas, TX (US); Arjun DUGAL, Dallas, TX (US); Maitreya KUNDURTHY, Richardson, TX (US); Krish ARUNACHALAM THAYAPPAN, McLean, VA (US); Meshach JOSHUA, Little Elm, TX (US)

(73) Assignee: Capital One Services, LLC, McLean, VA (US)

(21) Appl. No.: 16/732,070

(22) Filed: Dec. 31, 2019

(51) Int. Cl. G06Q 30/02

(52) U.S. Cl. CPC G06Q 30/0276; G06Q 30/0277; G06Q 30/0272; G06Q 30/0201

(57) ABSTRACT

Various embodiments are directed to integrating at least data aggregation, marketing content creation, and fulfillment into a single marketing platform with security features layered in to each of the aforementioned aspects of the platform. In examples, the marketing platform may include at least four components: a data engine, a content engine, a fulfillment engine, and a real-time marketing analytics and monitoring component. The data engine may receive and process data from one or more data sources, the content engine may allow marketing content to be created and approved, and the fulfillment engine may deliver the marketing content via one or more channels. The security features may be configured such that personally identifiable information (PII) or sensitive data is handled and processed securely and appropriately.

### BACKGROUND

A marketing platform refers to software platforms and technologies designed for marketing departments and organizations to more effectively market products on multiple channels online, such as e-mail, social media, websites, etc., and automate various repetitive tasks that may be undertaken on a regular basis in a marketing campaign. A tool that allows a user to design, execute, and automate a time-bound marketing workflow may be called a marketing automation platform.

Businesses, however, may experience various challenges when implementing out-of-the-box marketing automation platforms. For example, marketing automation platforms may be very expensive and costs anywhere between hundreds of thousands to millions of dollars annually. Moreover, out-of-the-box platforms may not provide the customization and flexibility that most businesses need to run specific marketing campaigns. Further, for financial service institutions, existing platforms may not provide the data security safeguards that are required to protect customer information. Even if security agreements for protecting customer information are in place, the onboarding time that it would take for the security features to be completely functional on third-party platforms may take months, if not years.

### SUMMARY

Various embodiments are generally directed to integrating at least data aggregation, marketing content creation, and fulfillment into a single marketing platform with security features layered in to each of the aforementioned aspects of the platform. In examples, the marketing platform may include at least four components: a data engine, a content engine, a fulfillment engine, and a real-time marketing analytics and monitoring component. The data engine may receive and process data from one or more data sources, the content engine may allow marketing content to be created and approved, and the fulfillment engine may deliver the marketing content via one or more channels. The security features may be configured such that personally identifiable information (PII) or sensitive data is handled and processed securely and appropriately.

### BRIEF DESCRIPTION OF THE DRAWINGS

FIG. 1 illustrates an example marketing platform in accordance with one or more embodiments.

FIG. 2 illustrates example process loops associated with features of a marketing platform in accordance with one or more embodiments.

FIG. 3 illustrates an example flow diagram in accordance with one or more embodiments.

FIG. 4 illustrates example security features in accordance with one or more embodiments.

FIG. 5 illustrates an example marketing data system in accordance with one or more embodiments.

FIG. 6 illustrates another example of a flow diagram in accordance with one or more embodiments.

FIG. 7 illustrates an example computing architecture of a computing device in accordance with one or more embodiments.

FIG. 8 illustrates an example communications architecture in accordance with one or more embodiments.

### DETAILED DESCRIPTION

Various embodiments are generally directed to integrating at least data aggregation, marketing content creation, and fulfillment into a single marketing platform. In embodiments, the marketing platform may include at least four components: a data engine, a content engine, a fulfillment engine, and a real-time marketing analytics and monitoring component.

According to one example, the data engine may be a data framework that automatically receives and processes data from various internal and external sources. According to another example, the content engine may enable business units to create marketing content for various products corresponding to one or more different types of customers, audiences, populations based on various rules (e.g., filters, suppressions) using, for instance, content templates. In some examples, a content management system may be used with the content creation engine to manage the content, facilitate content approval, and deliver the content on one or more channels.

According to yet another example, the fulfillment engine may allow delivery and fulfillment of the marketing content on the one or more channels (e.g., e-mail, direct mail, display advertising, paid search advertising, affiliate marketing and video advertising, etc.). An integrated scheduler component may allow the scheduling of marketing content delivery at predefined intervals. Moreover, the business units may be able to create offers, segment targeted customers or prospective customers, and execute marketing campaigns within the user interface associated with the fulfillment engine. According to a further example, the real-time marketing analytics and monitoring component may measure and track the effectiveness of marketing content in real-time or near real-time, and based on the analysis and/or monitoring, the component may generate user alerts and trigger one or more associated actions.

Moreover, security features may be layered onto various marketing processes or stages. As will be further described below, personally indefinable information (PII) extracted from acquired data may be tokenized at a data staging process, and further, national provider identifier (NPI) and PII filtering may be performed on the acquired data. In the marketing data platform, one or more of the security features may include role-based access control, multi-factor authentication (MFA), and/or least privileged access. Further, the fulfillment engine may include security features such as role-based application control and/or network isolation.

As described above, out-of-the-box marketing automation platforms are very expensive and time-consuming to customize and configure according to the specific needs and requirements of a user, such as a financial service institution requiring heightened security features and customer data protection. The embodiments, examples, and aspects of the present disclosure overcome and are advantageous over the previous solutions in that a single marketing platform seamlessly and efficiently integrates in real-time data acquisition, content creation, fulfillment, and marketing analytics and monitoring.

Reference is now made to the drawings, where like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form to facilitate a description thereof. The intention is to cover all modifications, equivalents, and alternatives within the scope of the claims.

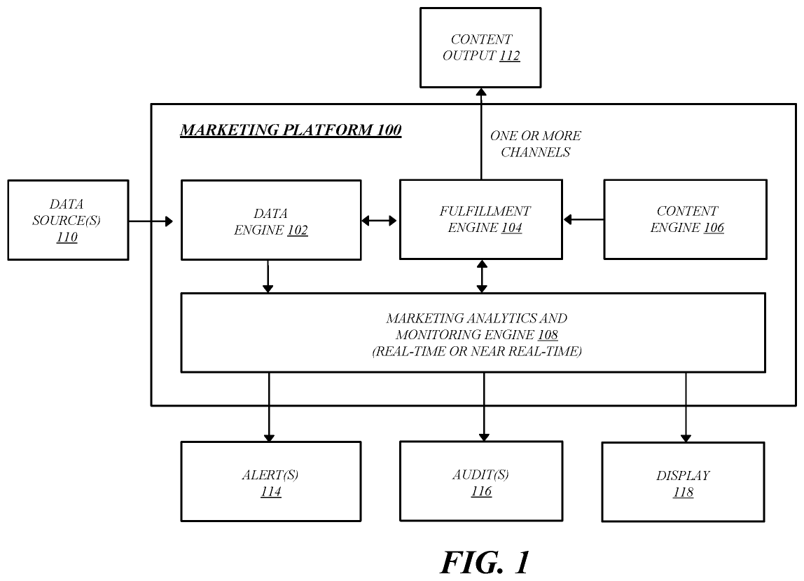

FIG. 1 illustrates an example marketing platform 100 according to embodiments. As shown, the marketing platform 100 may include at least a data engine 102, a fulfillment engine 104, a content engine 106, and a marketing analytics and monitoring engine 108. It may be understood that the marketing platform 100 and the components therein may be executed, run, and/or supported by one or more computing devices. It may also be understood that one or more of these components in the platform 100, for example, the analytics and monitoring engine 108 is not required to be configured or provided within the platform 100, and thus, may be provided or configured externally.

In examples, the data engine 102 may receive data from internal or external data sources 110. The data sources may include customer and/or marketing models, display marketing performance data, video marketing performance data, search engine marketing performance data, website analytics, customer browsing history data, etc. The data engine 102 may then process or stage the data and provide the processed or staged data to the fulfillment engine 104 and/or the marketing analytics and monitoring engine 108, as shown. As will be further described below, the data engine may perform various security features to protect customer information, such as tokenizing personally identifiable information (PII) related to the customers or otherwise filtering any sensitive information.

According to embodiments, the content engine 106 may provide marketing content to the fulfillment engine 104. For example, the content engine allows users, e.g., business units, to build product-related experiences for specific sets of customers based on associated rules, such as filters, suppressions, etc. For example, the content engine 106 may be configured such that a product is offered to one or more customers meeting predetermined criteria, e.g., the customers are offered a vehicle refinancing package at a predefined interest rate if they meet a predefined credit score. In examples, content templates may be used to generate the marketing content. Further, the content engine 106 allows for the approval of the generated content and the delivery of such content.

The fulfillment engine 104 may be a component of the marketing platform 100 that enables delivery and fulfillment of content output 112, such as marketing content, via one or more channels for various products. The one or more channels may include e-mail, direct messaging, video, short message service (SMS), search engine marketing (SEM) platform, an application (or otherwise referred to as an “app”), display advertising, direct mail, paid search advertising, and/or affiliate marketing and video advertising. In some examples, an adapter framework may facilitate the delivery and fulfillment of the content output 112 from the fulfillment engine 104. Moreover, an integrated scheduler may be used by the fulfillment engine 104 to schedule the delivery of the content output 112 at one or more predetermined intervals, e.g., seconds, minutes, hours, days, etc.

In further examples, the marketing analytics and monitoring engine 108 may communicate with the data engine 102 and/or the fulfillment engine 104 to perform analytics and monitoring in real-time or near real-time. The analytics and monitoring engine 108 may measure and track the effectiveness of the marketing content and/or the channel-product or channel-content combinations. Based on the analysis and monitoring performed by the engine 108, alert(s) 114 may be generated. In examples, the alerts may include dashboard alerts, email alerts, SMS alerts, etc. And based on the alert(s) 114, one or more types of actions may be triggered. For instance, measured or tracked effectiveness may include how the marketing content is received by customers, e.g., based on whether a customer acts on the content, based on whether customer feedback on the content is received, etc.

For example, if a display advertisement is not being displayed correctly via e-mail messages, then the marketing analytics and monitoring engine 108 may alert the user, e.g., appropriate business unit, and may trigger an action to temporarily stop outputting that display advertisement via the e-mail channel. In another example, if a particular type of marketing content tailored for a specific customer (or a set of customers) is sent to different customers, the engine 108 may provide an alert (e.g., correct customer-marketing content association is checked). Moreover, one or more audits 116 may be generated by the analytics and monitoring engine of at least the data engine 102 and the fulfillment engine 104 of the marketing platform 100.

It may be understood that users may be able to interact with the marketing platform 100 and the various components therein, e.g., the data engine 102, the fulfillment engine 104, the content engine 106, the marketing analytics and monitoring engine 108, via a global user interface and/or a user interface for each component of the platform 100, where applicable.

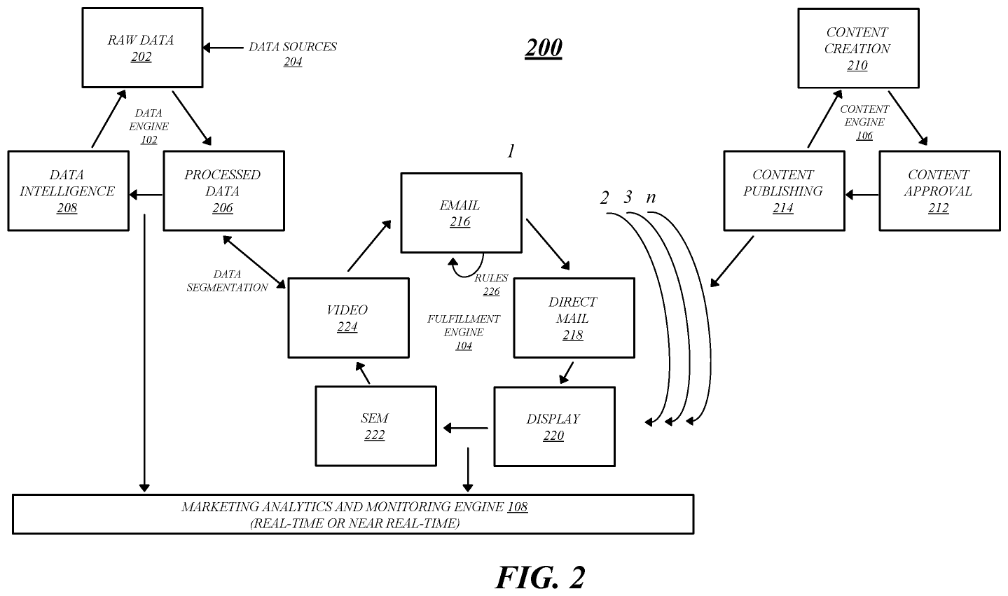

FIG. 2 illustrates example process loops 200 associated with the data, content creation, and fulfillment processes performed by a marketing platform according to embodiments. For ease of explanation, the components of the marketing platform 100 illustrated in FIG. 1 will be used to describe the various process loops in the flow diagram 200. While the arrows illustrated in the diagram 200 indicate a certain flow or direction in the processes and process loops, they are to be understood as examples only and the shown process flows are not limited thereto.

As shown, the process loops may be separated by component. At the data engine 102, the process loop may first begin by acquiring raw data 202 from data sources 204, which may then be processed to obtain processed data 206. The processed data 206 may be further analyzed to acquire data intelligence 208. The data intelligence can be a marketing score or right time to reach an individual etc. As further shown, data from any part of the process loop associated with the data engine 102 may be provided to the marketing analytics and monitoring engine 108.

In the process loop associated with the content engine 106, the process may begin by performing content creation 210. As described above, one or more business units of a financial service institution may be creators of the marketing content. For example, content may be a vehicle refinancing product directed to a customer with high interest vehicle payments. In another example, content directed to a specific type of credit card may be created for a set of customers having a predefined threshold credit score. The created content may then be approved, e.g., content approval 212, and thereafter published, e.g., content publishing 214. The published content may be provided to the fulfillment engine 104, as shown.

As described above, the fulfillment engine 104 may deliver the published content from the content engine 106 to one or more customers via one or more channels. For example, the process loop may first begin by delivering marketing content via e-mail 216, then by direct mail 218, thereafter by display advertising 220, then by SEM 222, and by video advertising 224. In examples, the process loop may run two, three, up to “n” number of times, as illustrated, based on the amount of marketing content to be delivered and fulfilled. Moreover, as shown, the process loop may be configured and customized by way of rules 226. For instance, if specific marketing content should not be delivered via a particular channel, such as direct mail 218, then the rules 228 may be configured such that the direct mail 218 channel is skipped. As further shown, any data from the process loop associated with the fulfillment engine may also be provided or fed to the marketing analytics and monitoring engine 108.

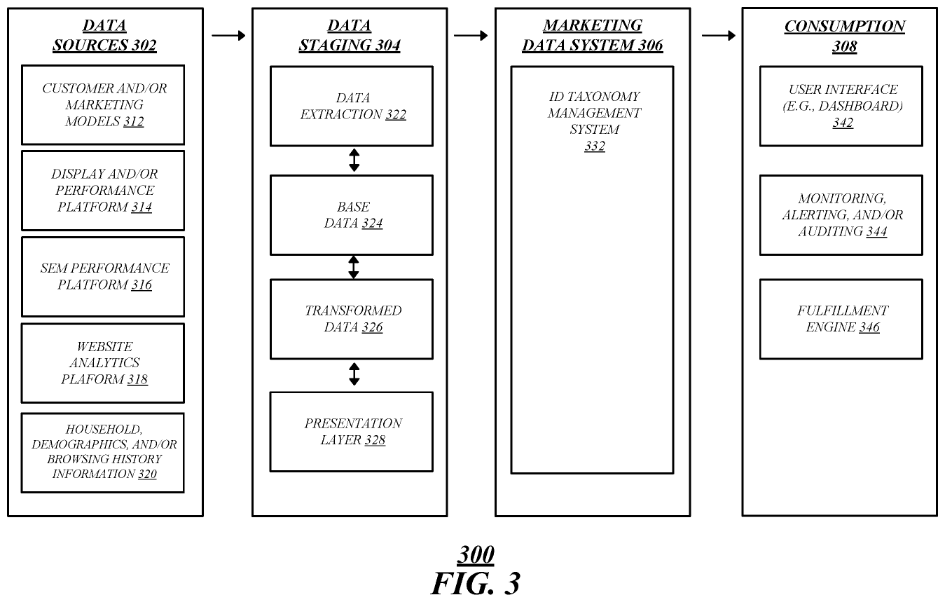

FIG. 3 illustrates another example of a flow diagram 300 according to embodiments. The flow diagram 300 shows how data may be processed and consumed for at least delivering marketing content. It may be understood that one or more of the blocks illustrated in the flow diagram 300 may be performed by or implemented in a marketing platform configured similarly to the marketing platform 100 of FIG. 1.

As shown, data may be acquired from one or more different types of data sources 302. Data sources 302 may include at least customer and/or marketing models 312, display and/or performance platform 314, SEM performance platform 316, website analytics platform 318, and household, demographics, and/or browsing history information 320.

According to examples, the data from the data sources 302 may be processed and staged at the data staging block 304. For instance, data extraction 332 may be performed on the data. It may be understood that data extraction may be the act or process of retrieving data out of data sources for further data processing or data storage. Base data 324 may be obtained from the performed data extraction 322, which can be further processed to generate transformed data 326. In examples, the base data 324 may be data necessary or required to create marketing content or provide the appropriate level of product-related detail in the marketing content. As will be further described below, in some examples, the data may be processed to generate the transformed data 326 to remove or filter out any PII or sensitive customer information. The transformed data 326 may then be provided to a presentation layer 328, which may be configured to present the data to an application layer in at least a standardized format.

In further examples, the base data 324 and/or the transformed data 326 may be provided to a marketing data system 306. Based at least in part on the use-purpose and/or the access level of the user, access to the base data 324 may be blocked and only the transformed data 326 may be provided. As illustrated, the marketing data system 306 may include at least an identifier (ID) taxonomy management system 332. As will be further described below, the ID taxonomy management system may at least perform stitching and/or aggregation of the processed data to form a data mart (e.g., a star schema, snowflake schema, etc.). Data from the data mart may then be extracted by a data extraction program in the ID taxonomy management system for providing tables and/or views on data visualization tools.

As illustrated, the data processed and managed by the marketing data system may be provided for consumption 308. For example, the data may be consumed by one or more user interface, such as a dashboard. In another example, the data may be consumed for monitoring, alerting, and/or auditing 334. In yet a further example, the data may be provided to a fulfillment engine 346 for delivering marketing content on one or more channels.

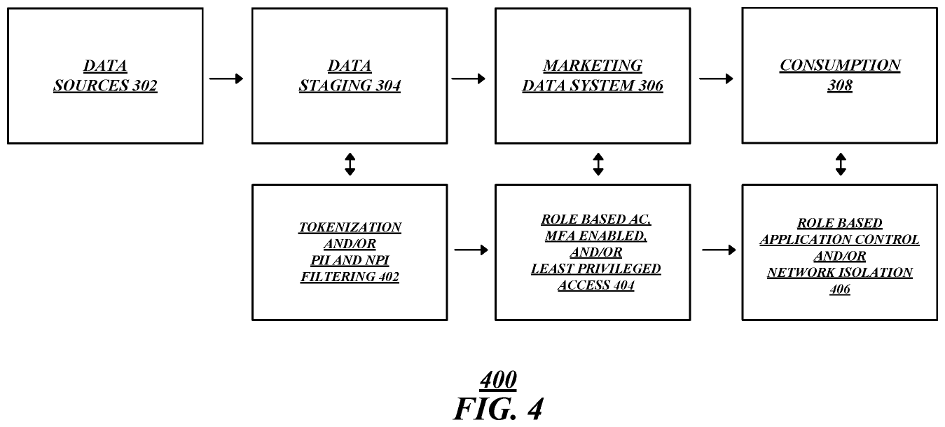

FIG. 4 illustrates example security features 400 implemented in the data acquisition, processing, management, and consumption process according to embodiments. For ease of explanation, the flow diagram 300 of FIG. 3 will be used to describe the security features 400.

As shown, when data has been acquired from the data sources 302 and processed at the data staging 304 block, analysis may be performed on the data to determine whether there is any sensitive customer information, such as personally identifiable information (PII), that should be scrubbed or filtered. PII may include customer credit numbers, debit card numbers, customer account numbers, social security numbers, birthdates, home addresses, work addresses, various types of phone numbers, account-related PIN numbers, credit scores, credit histories, account balances, transaction amounts and other transaction-related information, national provider identifier (NPI) information, etc.

In examples, tokenization and/or PII and NPI filtering 402 may be performed on any sensitive information. The term “tokenization,” “tokenize,” or any other variation thereof may be understood to mean the process of substituting sensitive data elements with non-sensitive equivalents, which may be referred to as “tokens,” where the tokens have no extrinsic or exploitable meaning or value. Moreover, filtering may involve applications or any suitable tools that use filters to remove PII, NPI, or any other types of sensitive information. As described above, tokenization and/or PII filtering may be applied to the base data that has been extraction from the data sources 302, which may generate transformed data that can be used by the marketing data system 306 in a safe, secure, and compliant manner.

In the marketing data system 306, various security features may be integrated, such as role-based access control (AC), MFA enabled access, and/or least privileged access 404. For example, role-based access control may involve restricting access (network access or otherwise) based on a person's role within an organization and the level of access associated with that person. Thus, users may be designated as an administrator, a specialist, an end-user, where varying levels of access may be tailored to such roles.

Moreover, it may be understood that multifactor authentication (MFA) is a security feature that requires more than one method of authentication from independent categories of credentials (e.g., PIN authentication, password authentication, e-mail authentication, phone number authentication, etc.) to verify a user's identity for login, use, access, or performing other types of transactions.

Further, least privileged access may be understood to be a technique in which every module (e.g., process, user, program, etc.) in a computing environment must be able to access only the information and resources that are necessary for its legitimate purposes. For instance, least privileged access may involve giving a user account only those privileges that are essential to performing its intended function.

In at least that regard, users, persons, programs, modules, etc. running in or supporting the marketing data system 306 may be restricted to the above described security features.

Within the consumption 308 block, security features such as role-based application control and/or network isolation may be implemented. Role-based application control may be a security feature similar to role-based access control described above. Thus, control or access to the applications that execute the various consumption-based programs in the consumption block 308 may be restricted to a user's level of access. Moreover, network segmentation or network isolation may be implemented, which may involve creating “silos” within the network that separate assets in the networked environment based on the function of the asset within the organization or based on other types of predefined schemas.

Accordingly, one of the many advantages of the marketing platform described herein is that numerous types of security features may be implemented throughout the data handling processes to ensure that sensitive information (customer PII, etc.) is protected and appropriately handled.

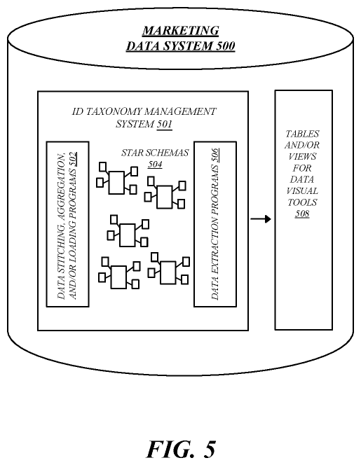

FIG. 5 illustrates an example marketing data system 500 according to embodiments. The marketing data system 500 may be similar to the marketing data system 306 described in FIG. 3. As shown, the marketing data system 500 includes an ID taxonomy management system 501, which receives, process, and outputs data. The data may be processed by data stitching, aggregation, and/or loading programs 502 to generate, create, or form a data mart. Data processing by way of data stitching or data aggregation may refer to putting together one or more data sets to engage with customers in a more personalized and efficient way. For example, data may be stitched according to a data schema associated with the data mart and tailored according to customer habits, tendencies, characteristics, patterns, intent, and other types of customer-unique information, which may be derived from the one or more data sources. Further, data marts may be understood to be structures or access patterns for retrieving the processed, stitched, and/or aggregated client-facing or customer-facing data. In examples, the data mart may be associated with a business unit of a company or the like.

As further illustrated, the data mart may be organized into star schemas 504, which may include one or more fact tables that reference a number of dimension tables. It may be understood that the star schemas may separate business process data into facts, which may hold measurable, quantitative data about a business unit, customers, etc. and also dimensions that are descriptive attributes related to fact data. Moreover, such data and facts organized by the star schemas 504 may be extracted by data extraction programs 506, which may be programmatically interfaced with one or more components, such as the above-described fulfillment engine. The data may be extracted by the data extraction programs 506 based at least in part on how the data will be utilized, for example, if data related to a certain set of customers and specific product is needed, then such data may be extracted from the data mart according to that input. The extracted data may be provided to data visualization tools 508 for interfacing and viewing.

As described above, various security features, such as role-based access control, MFA enabled access, and/or least privileged access may be implemented throughout to protect sensitive data contained in the marketing data system 500.

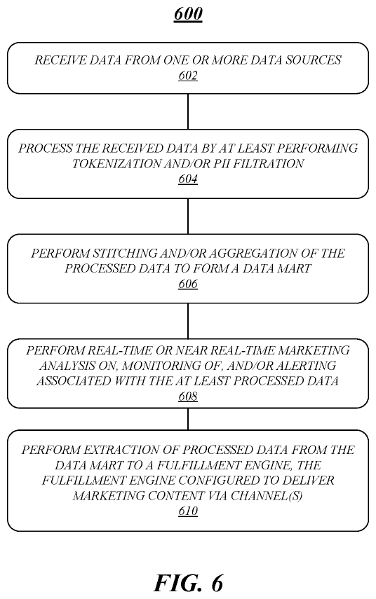

FIG. 6 illustrates an example flow diagram 600 according to one or more embodiments. It may be understood that the features associated with the illustrated blocks may be performed or executed by one or more computing devices and/or processing circuitry contained therein that can run, support, execute a marketing platform, such as the one illustrated in FIG. 1.

At block 602, data from one or more data sources may be received by a marketing platform. As described above, the one or more data sources may include at least customer and/or marketing models, display and/or performance platform, SEM performance platform, web site analytics platform, and household, demographics, and/or browsing history information. In examples, a data engine may be configured to receive such data.

At block 604, upon receiving the data, the data may be processed by at least performing tokenization and/or PII filtration to remove or appropriately handle any sensitive customer information, as described above. In the examples, any information matching or resembling a predefined set of PII information may be removed from the data or hidden from use.

At block 606, the processed data may then be stitched and/or aggregated to form a data mart. The data mart may be organized based on a star schema, which may relate fact data in a comprehensive and cohesive manner. At block 608, real-time or near real-time marketing analysis and monitoring may be performed on the data processed at block 606. Based on the analysis and monitoring of the data, one or more alerts may be triggered. For example, if a user is interested in acquiring a specific type of data, an alert associated with that data may be set, which may be triggered when the data has been processed.

At block 610, the processed data at block 606 may be extracted using data extraction programs, which may then be provided to a fulfillment engine to deliver marking content via one or more channels, e.g., e-mail, direct messaging, video, short message service (SMS), search engine marketing (SEM) platform, an application (or otherwise referred to as an “app”), display advertising, direct mail, paid search advertising, affiliate marketing and video advertising, etc. As described above, the fulfillment engine may receive marketing content, which may be used in conjunction with the extracted data provided thereto for delivering the marketing content.

It may be understood that the blocks illustrated in FIG. 6 are not limited to any specific order. One or more of the blocks may be performed or executed simultaneously or near simultaneously.

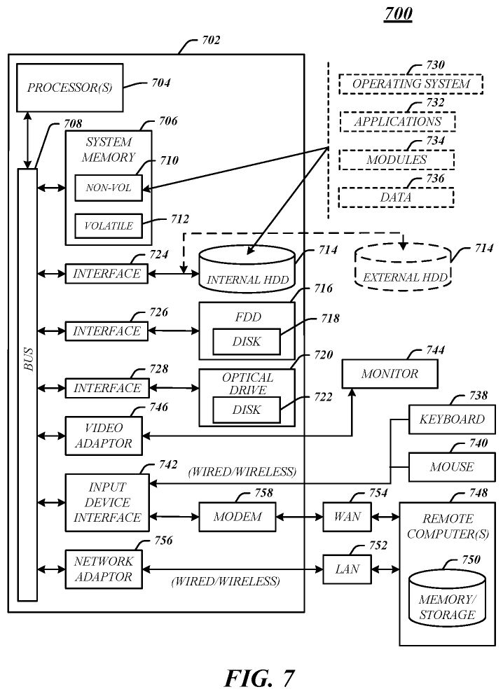

FIG. 7 illustrates an embodiment of an exemplary computing architecture 700, e.g., of a computing device, such as a desktop computer, laptop, tablet computer, mobile computer, smartphone, etc., suitable for implementing various embodiments as previously described. In one embodiment, the computing architecture 700 may include or be implemented as part of a system, which will be further described below. In examples, one or more computing devices and the processing circuitries thereof may be configured to at least run, execute, support, or provide the marketing platform, e.g., marketing platform 100 and related functionalities.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 includes processor 704, a system memory 706 and a system bus 708. The processor 704 can be any of various commercially available processors, processing circuitry, central processing unit (CPU), a dedicated processor, a field-programmable gate array (FPGA), etc.

The system bus 708 provides an interface for system components including, but not limited to, the system memory 706 to the processor 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components of the system 800.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 704 through an input device interface 742 that is coupled to the system bus 708 but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754 or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.118 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1-6 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

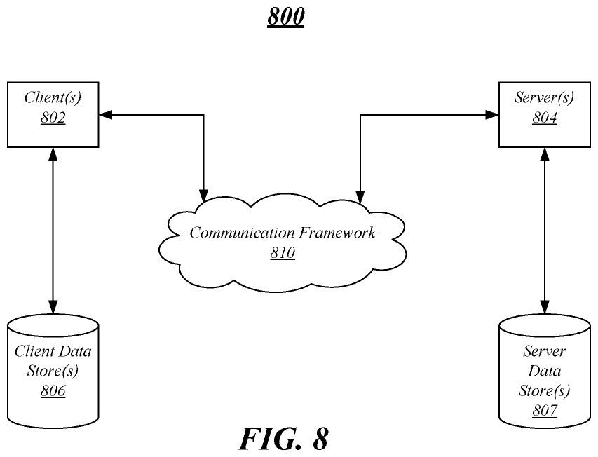

FIG. 8 is a block diagram depicting an exemplary communications architecture 800 suitable for implementing various embodiments. For example, one or more computing devices may communicate with each other via a communications framework, such as a network. At least a first computing device connected to the network may be one or more server computers, which may be implemented as a back-end server or a cloud-computing server, which may run the marketing platform described herein, e.g., marketing platform 100, and perform all related functionalities. At least a second computing device connected to the network may be a user computing device, such as a mobile device (e.g., laptop, smartphone, tablet computer, etc.) or any other suitable computing device that belongs to the user, e.g., employee of a business unit of a financial service institution. In other examples, at least the second computing device may be computing devices that support or run any of the above-described data sources, e.g., data sources 302. In further examples, at least the second computing device may be a computing device belonging to a customer.

The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 includes one or more clients 802 and servers 804. The one or more clients 802 and the servers 804 are operatively connected to one or more respective client data stores 806 and server data stores 807 that can be employed to store information local to the respective clients 802 and servers 804, such as cookies and/or associated contextual information.

The clients 802 and the servers 804 may communicate information between each other using a communication framework 810. The communications framework 810 may implement any well-known communications techniques and protocols. The communications framework 810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 810 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose and may be selectively activated or reconfigured by a computer program stored in the computer. The procedures presented herein are not inherently related to a particular computer or other apparatus. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A system comprising:
one or more first computing devices comprising:
memory storing one or more instructions; and
one or more processors, coupled with the memory, operable to execute the one or more instructions, that when executed, cause the one or more processors to:
receive data from one or more data sources, wherein the one or more data sources include one or more of the following: (i) a customer-based-model, (ii) a marketing-based model, (iii) a credit history service, (iv) display and/or video performance platform, (v) search engine marketing (SEM) performance platform, (vi) website analytics platform, (vii) household information, (viii) demographics information, and (ix) browsing history;
determine whether the received data from the one or more data sources contain any customer personally identifiable information (PII);
tokenize, based on the determination, one or more portions of the customer PII in the received data with one or more tokens to generate tokenized data;
stitch the received data including the tokenized data to form a data mart according to a data schema associated with the data mart and the data mart organized based at least in part on customer-unique information derived from the one or more data sources, wherein the data mart integrates role-based access control for restricting or granting access to data in the data mart based on a threshold of a user access level, multifactor authentication enabled access, and least privileged access for enabling access to only predefined portions of the data in the data mart corresponding to the user access level;
fulfill and deliver marketing content, via one or more channels, the marketing content created based on customer data extracted from the data mart by a data extraction program; and
monitor the marketing content and channel-content combinations for an abnormality, and based on the monitoring, generate and send an alert to a user if the abnormality is detected, and
wherein the fulfillment and delivery and monitoring of the marketing content integrates role-based application control for restricting or granting access to an application based on the threshold of the user access level and network isolation for providing one or more isolated portions of at least the system.

2. The system of claim 1, wherein the PII includes one or more of the following: (i) a credit card number, (ii) a debit card number, (iii) an account number, (iv) a social security number, (v) a birthdate, (vi) an address, (vii) a phone number, (viii) a pin number, (ix) a credit history score, (x) an account balance, (xi) one or more transaction amounts, and (xii) a national provider identifier (NPI).

3. The system of claim 1, wherein the data mart includes one or more of the following: (i) a star schema and (ii) a snowflake schema.

4. The system of claim 1, wherein the stitching and/or aggregation of the processed data includes at least compiling the data according to a data schema associated with the data mart and based at least in part on the customer-unique information derived from the one or more data sources.

5. The system of claim 1, wherein the fulfillment engine receives the marketing content from a content engine.

6. The system of claim 5, wherein the content engine is configured to:
create the marketing content or provide ability to create the marketing content;
receive approval of the marketing content or provide approval of the marketing content; and
publish the marketing content.

7. The system of claim 1, wherein the fulfillment engine includes at least an integrated scheduler, the integrated scheduler configured to schedule the delivery of the marketing content at a predefined time.

8. The system of claim 1, wherein the one or more channels include one or more of the following: (i) e-mail, (ii) direct messaging, (iii) video, (iv) short message service (SMS), (v) search engine marketing (SEM) platform, (vi) an application, (vii) display advertising, (viii) direct mail, (ix) paid search advertising, and (x) affiliate marketing and video advertising.

9. The system of claim 1, wherein the real-time or near real-time marketing analysis, monitoring, and/or alerting comprises the one or more processors to measure or track effectiveness of (i) the marketing content and/or (ii) a channel-content combination.

10. The system of claim 9, wherein the one or more processors is further caused to generate one or more alerts based on the measured or tracked effectiveness, wherein the measured or tracked effectiveness includes at least: (i) customer feedback, (ii) customer action on the marketing content, and/or (iii) correct customer-marketing content association.

11. The system of claim 10, wherein the effectiveness and/or the one or more alerts are provided to a real-time or near real-time dashboard via a user interface.

12. The system of claim 1, wherein the extraction of the processed data from the data mart is: (i) performed by a data extraction program programmatically interfaced with the fulfillment engine and (ii) based at least in part on how the processed data will be utilized by the fulfillment engine.

13-14. (canceled)

15. The system of claim 1, wherein the marketing content is personalized to a customer based at least in part on the received data from the one or more data sources, and wherein the received data is associated with the customer.

16. A method comprising:
receiving, via one or more computing devices, data from one or more data sources, wherein the one or more data sources include one or more of the following: (i) a customer-based-model, (ii) a marketing-based model, (iii) a credit history service, (iv) display and/or video performance platform, (v) search engine marketing (SEM) performance platform, (vi) website analytics platform, (vii) household information, (viii) demographics information, and (ix) browsing history;
determining, via the one or more computing devices, whether the received data from the one or more data sources contain any customer personally identifiable information (PII);
tokenizing, based on the determining, one or more portions of the customer PII in the received data with one or more tokens to generate tokenized data;
stitching, via the one or more computing devices, the received data including the tokenized data to form a data mart according to a data schema associated with the data mart and the data mart organized based at least in part on customer-unique information derived from the one or more data sources, wherein the data mart integrates role-based access control for restricting or granting access to data in the data mart based on a threshold of a user access level, multifactor authentication enabled access, and least privileged access for enabling access to only predefined portions of the data in the data mart corresponding to the user access level;
fulfilling and delivering marketing content, via one or more channels, the marketing content created based on customer data extracted from the data mart by a data extraction program; and
monitoring the marketing content and channel-content combinations for an abnormality, and based on the monitoring, generate and send an alert to a user if the abnormality is detected, and
wherein the fulfilling and delivering and the monitoring of the marketing content integrates role-based application control for restricting or granting access to an application based on the threshold of the user access level and network isolation for providing one or more isolated portions of at least the system.

17. The method of claim 16, wherein the one or more data sources include one or more of the following: (i) a customer-based-model, (ii) a marketing-based model, (iii) a credit history service, (iv) display and/or video performance platform, (v) search engine marketing (SEM) performance platform, (vi) website analytics platform, (vii) household information, (viii) demographics information, and (ix) browsing history.

18. (canceled)

19. The method of claim 16, wherein the performing real-time or near real-time marketing analysis, monitoring, and/or alerting comprises measuring or tracking effectiveness of (i) the marketing content and/or (ii) a channel-content combination

20. A non-transitory computer-readable storage medium storing computer-readable program code executable by a processor to:
receive data from one or more data sources, wherein the one or more data sources include one or more of the following: (i) a customer-based-model, (ii) a marketing-based model, (iii) a credit history service, (iv) display and/or video performance platform, (v) search engine marketing (SEM) performance platform, (vi) website analytics platform, (vii) household information, (viii) demographics information, and (ix) browsing history;
determine whether the received data from the one or more data sources contain any customer personally identifiable information (PII);
tokenize, based on the determination, one or more portions of the customer PII in the received data with one or more tokens to generate tokenized data;
stitch the received data including the tokenized data to form a data mart according to a data schema associated with the data mart and the data mart organized based at least in part on customer-unique information derived from the one or more data sources, wherein the data mart integrates role-based access control for restricting or granting access to data in the data mart based on a threshold of a user access level, multifactor authentication enabled access, and least privileged access for enabling access to only predefined portions of the data in the data mart corresponding to the user access level;
fulfill and deliver marketing content, via one or more channels, the marketing content created based on customer data extracted from the data mart by a data extraction program; and
monitor the marketing content and channel-content combinations for an abnormality, and based on the monitoring, generate and send an alert to a user if the abnormality is detected, and
wherein the fulfillment and delivery and monitoring of the marketing content integrates role-based application control for restricting or granting access to an application based on the threshold of the user access level and network isolation for providing one or more isolated portions of at least the system.
